(19) United States
(12) Patent Application Publication
(10) Pub. No.: US 2003/0217073 A1
(43) Pub. Date: Nov. 20, 2003

(54) Increasing the level of automation when scheduling and managing meetings

(76) Inventors: Dan E. Walther, Redmond, WA (US); Joseph Patrick Masterson, Renton, WA (US)

Correspondence Address: RICK D. NYDEGGER, WORKMAN, NYDEGGER & SEELEY, 1000 Eagle Gate Tower, 60 East South Temple, Salt Lake City, UT, 84111, US

(21) Appl. No.: 10/144,921

(22) Filed: May 14, 2002

(51) Int. Cl. G06F 17/00

(52) U.S. Cl. 707/104.1

(57) ABSTRACT

A managing computer system increases the level of automation when scheduling and managing meetings. A meeting scheduler determines that a meeting is to be scheduled and accesses information relevant to the availability of potential meeting attendants. Relevant information may include time availability of attendants and locations, priority levels associated with attendants, and whether or not specific attendants are required. Based on the relevant information, the meeting scheduler automatically determines at least one potential meeting that satisfies predetermined criteria. If the circumstances surrounding a currently-scheduled meeting change, information relevant to the currently-scheduled meeting is identified. Identified information may include changes in the status of meeting attendants, meeting locations, and documents associated with a meeting. The identified information may be automatically accessed and made available to at least one meeting attendant. Information may be made available by transferring electronic messages to computer systems associated with meeting attendants.

### BACKGROUND OF THE INVENTION

1. The Field of the Invention

The present invention relates to scheduling and managing meetings. More specifically, the present invention relates to systems, methods, and computer program products for increasing the level of automation when using electronic data to schedule meetings and notify meeting attendants of relevant information associated with currently-scheduled meetings.

2. Background and Related Art

Computer systems are often coupled to one another through networks that allow the computer systems to exchange data electronically. This is beneficial, as transporting data electronically is often much faster than transporting data using other methods. The electronic transfer of data has significantly reduced the effort required to schedule a meeting. Typically, scheduling applications store electronic data indicating when individuals are free and when they are busy (“free/busy time”). In many cases, an individual meeting organizer views the free/busy time for potential meeting participants and attempts to identify an appropriate meeting time based on the collective free/busy times of all potential meeting participants. That is, the individual meeting organizer uses the electronic data to attempt to identify a period of time where all potential meeting participants have free time.

However, current scheduling applications that utilize electronic data to aid in scheduling meetings have certain drawbacks. As the number of potential meeting participants increases, it is often difficult, if not impossible, to simultaneously view free/busy time for all potential meeting participants. Simultaneously viewing free/busy time may be especially problematic on mobile computer systems, which often include display devices with a reduced viewing area.

Another drawback is that conventional scheduling applications fail to consider data in addition to free/busy time when scheduling a meeting. Factors such as location, traffic, and weather may restrain a potential meeting participant's attendance at a meeting, even if the potential participant otherwise has free time. For example, if a potential meeting participant will take thirty minutes to get to a meeting, this potential participant may need to be available at 1:30 PM in order to schedule a 2:00 PM meeting. When scheduling a meeting, an individual meeting organizer may be burdened with determining this data for each potential meeting participant.

Other problems may occur if information relevant to a scheduled meeting changes. Conventional scheduling applications lack the management capabilities to notify meeting participants if information relevant to a scheduled meeting changes. For example, if a participant's availability for a scheduled meeting changes, especially during a critical time period immediately preceding the meeting, other meeting participants may not be notified. This may result in meeting participants wasting time, or if the meeting was scheduled for only two people may destroy the benefit of the meeting altogether.

Therefore, what are desired are systems, methods, and computer program products, for increasing the level of automation when scheduling meetings and when providing relevant information to participants.

### SUMMARY OF THE INVENTION

It is often desirable to schedule meetings based on electronic data gathered from a variety of locations. Such electronic data may be gathered from scheduling databases, global positioning system (“GPS”) databases, meeting attendant's personal databases, mapping databases, word processing documents, or the like. In accordance with the principles of the present invention, the level of automation is increased when scheduling meetings based on electronic data. It is also often desirable to provide relevant information for a currently-scheduled meeting to the meeting attendants. Such information may be in the form of electronic data gathered from the previous described locations. Likewise, in accordance with the principles of the present invention, relevant information for currently-scheduled meetings is provided to meeting attendants.

Some embodiments of the present invention may be practiced to schedule meetings for a user. When scheduling a meeting, it is first determined that a meeting is to be scheduled among a number of meeting attendants. It may be determined that a meeting is to be scheduled as a result of a user manually entering data into a scheduling computer system. Such entered data may indicate that a meeting is to be scheduled at a particular date, time, and/or location. In some embodiments, the scheduling computer system may automatically determine a meeting is to be scheduled. Meeting attendants may be selected from a list of possible meeting attendants that are stored in databases, for example, a contacts or calendar database. In some embodiments, a user may manually enter meeting attendants.

Information relevant to the availability of at least some of the number of meeting attendants is accessed. Relevant information for each potential attendant may include data indicating when an attendant is free and when they are busy (“free/busy time”), the location of an attendant, a priority level for an attendant, and whether or not an attendant is a required or optional attendant. Such relevant information may be accessed from different locations. For example, free/busy time may be accessed from calendar application and location information accessed from a GPS database.

Based on the relevant information, at least one potential meeting is automatically determined. Relevant information may be analyzed to determine a meeting time that satisfies predetermined criteria. Such predetermined criteria may include, for example, that a specified percentage of meeting attendants be available at a specified time, that all required attendants be available, that meeting attendants be available to attend in a specified location, etc. Analysis of relevant information may be performed by decision logic included in the scheduling computer system. After determining potential meeting times, the scheduling computer system may present a list of meetings to an output device.

In some embodiments of the present invention, the level of automation is increased when managing meetings for a user. More specifically, a currently-scheduled meeting that has a number of attendants is identified. A currently-scheduled meeting may be identified in response to data received at an input device, such as, for example, a keyboard. Likewise, a managing computer system may be configured to automatically identify a currently-scheduled meeting. After a currently-scheduled meeting is identified, relevant information associated with the currently-scheduled meeting is also identified. The managing computer system may refer to or search external databases and/or external file systems to identify relevant information. Identifying a meeting and relevant information may include identifying the time, date, location, and/or subject matter of the meeting, the estimated time of arrival, current location, and/or contact information for a specific meeting attendant, and/or documents related to the meeting.

Identified information is automatically accessed and automatically made available to at least one of the meeting attendants. This may include the managing computer system accessing the information from external databases and/or external file systems that were previously referred to or searched. The managing computer system may make relevant information available to a meeting attendant by sending an electronic message to a computer system associated with the meeting attendant. It may be that relevant information changes as result of a change in the availability of a meeting attendant or meeting location. For example, if a meeting attendant will be late to a meeting due to traffic congestion, other meeting attendants may be notified of the delay. The managing computer system may detect such changes and automatically suggest options for rescheduling meetings or automatically rescheduling meetings without input from meeting participants.

Increasing the level of automation when scheduling meetings reduces the amount of data that is interpreted by an individual meeting organizer. This promotes efficient scheduling of meetings and reduces the chance of human error in the scheduling process. Automatically accessing and providing relevant information to meeting attendants centralizes the distribution of such information. This promotes time efficiency by relieving individual meeting attendants from having to actively seek out the information. In a mobile environment, increased automation may provide certain safety benefits as well. For example, automatically updating the status of a meeting attendant, who is late due to traffic congestion, may free the meeting attendant from having to manually manipulate a mobile computer system. Thus, the meeting attendant may devote more attention to safe operation of their vehicle.

Additional features and advantages of the invention will be set forth in the description that follows, and in part will be obvious from the description, or may be learned by the practice of the invention. The features and advantages of the invention may be realized and obtained by means of the instruments and combinations particularly pointed out in the appended claims. These and other features of the present invention will become more fully apparent from the following description and appended claims, or may be learned by the practice of the invention as set forth hereinafter.

### BRIEF DESCRIPTION OF THE DRAWINGS

In order to describe the manner in which the above-recited and other advantages and features of the invention can be obtained, a more particular description of the invention briefly described above will be rendered by reference to specific embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1 illustrates an example of a telephonic device that provides a suitable operating environment for the present invention.

FIG. 2 illustrates an example of some of the functional components that may facilitate scheduling a meeting.

FIG. 3 illustrates an example of some of the functional components that may facilitate managing scheduled meetings.

FIG. 4 is a flow diagram illustrating an example of a method for a increasing the level of automation when scheduling a meeting.

FIG. 5 is a flow diagram illustrating an example of a method for increasing the level of automation when managing scheduled meetings.

FIG. 6 is a flow diagram illustrating an example of a method for rescheduling a currently-scheduled meeting.

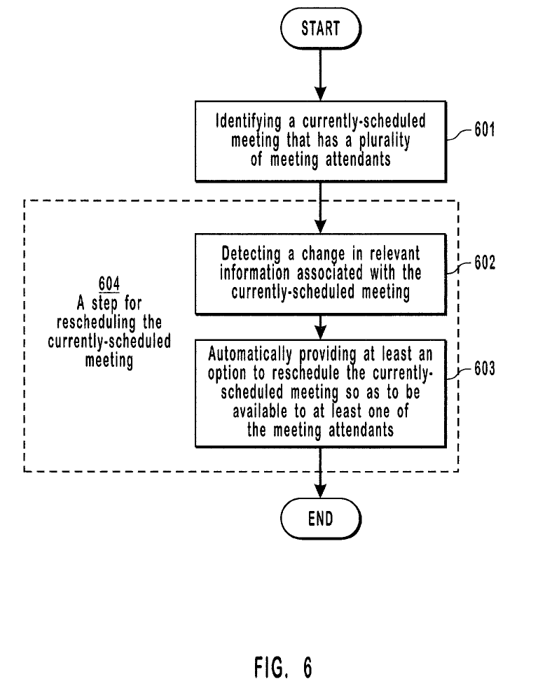

### DETAILED DESCRIPTION OF THE PREFERRED EMBODIMENTS

The present invention extends to methods, systems and computer program products for increasing the level of automation when scheduling and managing meetings. Relevant information is accessed from one or more databases that include information such as time availability, location availability, travel conditions, and documents that are associated with meetings and meeting participants. Based on relevant information, meetings may be automatically scheduled or changed and meeting participants may be notified of changes.

When scheduling a meeting, input is received that causes a scheduling computer system to determine that a meeting is to be scheduled among a plurality of meeting attendants. Information relevant to the availability of at least some of the plurality of meeting attendants is accessed. This may include accessing relevant information from calendar, contact, and/or other databases containing information pertinent to the availability of a meeting attendant. At least one potential meeting time is automatically determined based on the relevant information. This determination may include the scheduling computer system utilizing decision logic to determine if relevant information satisfies predetermined criteria.

When managing a meeting, a currently-scheduled meeting that has a plurality of meeting attendants is identified. Information relevant to the currently-scheduled meeting is automatically accessed. This may include accessing information from databases that include calendar data, location data, travel data, documents, or other information relevant to the ability to appropriately conduct the currently-scheduled meeting. Relevant information is automatically provided so as to be available to at least one of the meeting attendants.

The embodiments of the present invention may comprise a general-purpose or special-purpose computer system including various computer hardware components, which are discussed in greater detail below. Embodiments within the scope of the present invention also include computer-readable media for carrying or having computer-executable instructions or data structures stored thereon. Such computer-readable media may be any available media, which is accessible by a general-purpose or special-purpose computer system. By way of example, and not limitation, such computer-readable media can comprise physical storage media such as RAM, ROM, EPROM, CD-ROM or other optical disk storage, magnetic disk storage or other magnetic storage devices, or any other media which can be used to carry or store desired program code means in the form of computer-executable instructions or data structures and which may be accessed by a general-purpose or special-purpose computer system.

In this description and in the following claims, a “network” is defined as any architecture where two or more computer systems may exchange data with each other.

When information is transferred or provided over a network or another communications connection (either hardwired, wireless, or a combination of hardwired or wireless) to a computer system or computer device, the connection is properly viewed as a computer-readable medium. Thus, any such connection is properly termed a computer-readable medium. Combinations of the above should also be included within the scope of computer-readable media. Computer-executable instructions comprise, for example, instructions and data which cause a general-purpose computer system or special-purpose computer system to perform a certain function or group of functions.

In this description and in the following claims, a “computer system” is defined as one or more software modules, one or more hardware modules, or combinations thereof, that work together to perform operations on electronic data. For example, the definition of computer system includes the hardware components of a personal computer, as well as software modules, such as the operating system of the personal computer. The physical layout of the modules is not important. A computer system may include one or more computers coupled via a computer network. Likewise, a computer system may include a single physical device (such as a mobile phone or Personal Digital Assistant “PDA”) where internal modules (such as a memory and processor) work together to perform operations on electronic data.

Those skilled in the art will appreciate that the invention may be practiced in network computing environments with many types of computer system configurations, including personal computers, laptop computer, hand-held devices, multi-processor systems, microprocessor-based or programmable consumer electronics, network PCs, minicomputers, mainframe computers, mobile telephones, PDAs, pagers, and the like. The invention may also be practiced in distributed computing environments where local and remote computer systems, which are linked (either by hardwired links, wireless links, or by a combination of hardwired or wireless links) through a communication network, both perform tasks. In a distributed computing environment, program modules may be located in both local and remote memory storage devices.

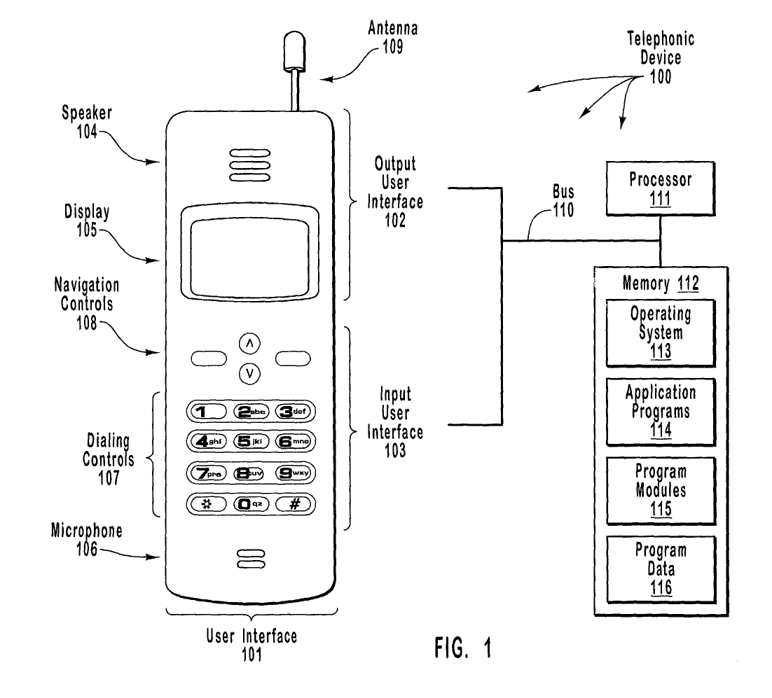

FIG. 1 and the following discussion are intended to provide a brief, general description of a suitable computing environment in which the invention may be implemented. Although not required, the invention will be described in the general context of computer-executable instructions, such as program modules, being executed by computer systems. Generally, program modules include routines, programs, objects, components, data structures, and the like, which perform particular tasks or implement particular abstract data types. Computer-executable instructions, associated data structures, and program modules represent examples of the program code means for executing steps of the methods disclosed herein. The particular sequences of such executable instructions or associated data structures represent examples of corresponding acts for implementing the functions described in such steps.

With reference to FIG. 1, a suitable operating environment for the principles of the invention includes a general-purpose computer system in the form of a telephonic device 100. The telephonic device 100 includes a user interface 101 for allowing a user to input information through an input user interface 103, and to review information presented via an output user interface 102. For example, the output user interface 102 includes a speaker 104 for presenting audio information to the user, as well as a display 105 for presenting visual information to the user. The telephonic device 100 may also have an antenna 109 if the telephonic device 100 has wireless capabilities.

The input user interface 103 may include a microphone 106 for translating audio information into electronic form. In addition, the input user interface 103 includes dialing controls 107 represented by 12 buttons through which a user may enter information. Input user interface 103 also includes navigation control buttons 108 that assist the user in navigating through various entries and options listed on display 105.

Although user interface 101 has the appearance of a mobile telephone, the unseen features of user interface 101 may allow for complex and flexible general-purpose processing capabilities. For example, telephonic device 100 also includes a processor 111 and a memory 112 that are connected to each other and to the user interface 101 via a bus 110. Memory 112 generally represents a wide variety of volatile and/or non-volatile memories and may include types of memory previously discussed. However, the particular type of memory used in telephonic device 100 is not important to the present invention. Telephonic device 100 may also include mass storage devices (not shown) similar to those associated with other general-purpose computer systems.

Program code means comprising one or more program modules may be stored in memory 112 or other storage devices as previously mentioned. The one or more program modules may include an operating system 113, one or more application programs 114, other program modules 115, and program data 116.

While FIG. 1 represents a suitable operating environment for the present invention, the principles of the present invention may be employed in any system that is capable of, with suitable modification if necessary, implementing the principles of the present invention. The environment illustrated in FIG. 1 is illustrative only and by no means represents even a small portion of the wide variety of environments in which the principles of the present invention may be implemented.

In this description and in the following claims, a “logical communication path” is defined as any communication path that may enable the transport of electronic data between two entities such as computer systems or modules. The actual physical representation of a communication path between two entities is not important and may change over time. A logical communication path may include portions of a system bus, a local area network, a wide area network, the Internet, combinations thereof, or portions of any other path that may facilitate the transport of electronic data. Logical communication paths may include hardwired links, wireless links, or a combination of hardwired links and wireless links. Logical communication paths may also include software or hardware modules that condition or format portions of data so as to make them accessible to components that implement the principles of the present invention. Such components may include, for example, proxies, routers, firewalls, or gateways. Logical communication paths may also include portions of a Virtual Private Network (“VPN”).In this description and in the following claims, “primary scheduling information” is defined as free/busy time for a meeting attendant.

In this description and in the following claims, “supplemental scheduling information” is defined as other information that is relevant to the scheduling of a meeting. Supplemental scheduling information can include, for example, contact information, Global Positioning System (“GPS”) data, map data, transit data, meeting attendant priorities, whether a meeting attendant is a required or optional attendant, and data files.

In accordance with the present invention, meeting schedulers, information access modules, information identifier modules, meeting identification modules, and information access modules as well as associated data, including predefined criteria and scheduled meetings databases may be stored and accessed from any of the computer-readable media associated with telephonic device 100. For example, portions of such modules and portions of associated program data may be included in operating system 113, application programs 114, program modules 115 and/or program data 116, for storage in memory 112. Portions of such modules and associated program data may also be stored in any of the mass storage devices previously described. Execution of such modules may be performed in a distributed environment as previously described.

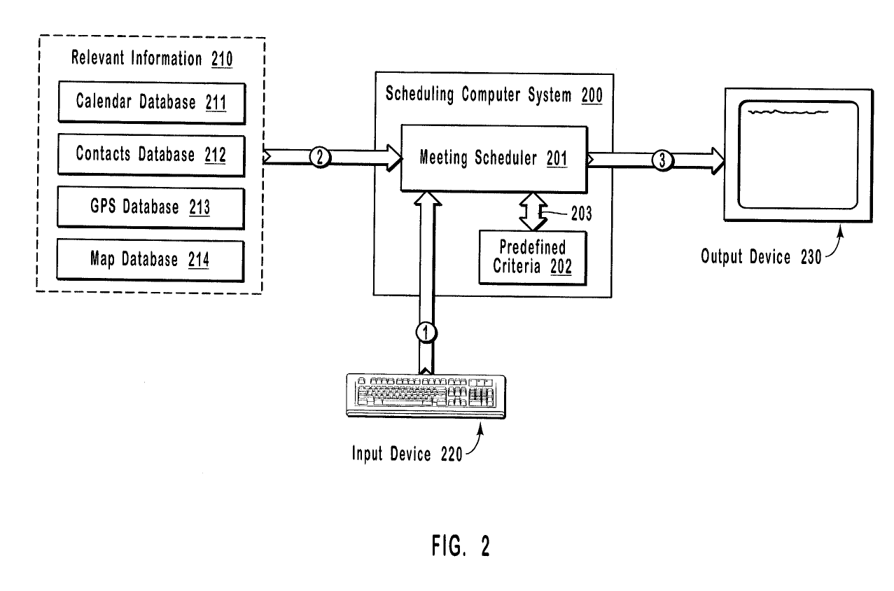

FIG. 2 illustrates an example of some of the functional components that may facilitate scheduling a meeting. Shown in FIG. 2 is scheduling computer system 200, which may be a general-purpose computer system that includes components similar to those previously discussed herein. Scheduling computer system 200 may include meeting scheduler 201 and predefined criteria 202. Meeting scheduler 201 automatic schedules a meeting by utilizing predefined criteria 202 and analyzing information relevant to the scheduling of a meeting. Meeting scheduler 201 may access and update predefined criteria via logical communication path 203.

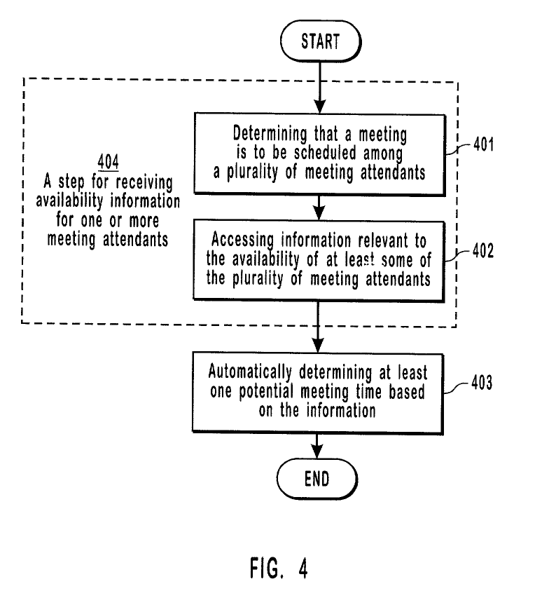

FIG. 4 is a flow diagram illustrating an example of a method for increasing the level of automation when scheduling a meeting. The method in FIG. 4 will be discussed with reference to the functional components included in FIG. 2.

The method in FIG. 4 begins with a step for receiving availability information for one or more meeting attendants (step 404). This may include scheduling computer system 200 receiving availability information for potential meeting attendants from databases included in relevant information 210. Relevant information 210 logically represents a store of information that may reside in disparate physical locations and that may be relevant to the scheduling of meetings. The databases included in relevant information 210 may contain information that is relevant to the identification of a potential meeting. Included in relevant information 210 is calendar database 211, which may include time availability data associated with possible meeting attendants. Also included is contacts database 212, which may include personal information associated with possible meeting attendants such as a business or home address, GPS database 213 which may include GPS data such as the current location of a possible meeting participant, and map database 214, which may include mapping data that may be matched to GPS data to indicate a location on a map.

It should be understood that the described databases are merely examples and that the contents of the different databases may include common information. For example, a calendar database and a contacts database may both include time availability data, as well as personal information for possible meeting participants. Further, it would be apparent to one skilled in the art, after having reviewed this description, that a variety of other databases, in addition to those previously described, may be utilized to receive availability information for meeting attendants.

Step 404 may include determining that a meeting is to be scheduled among a plurality of meeting attendants (act 401). Meeting scheduler 201 may receive data indicating that a meeting is to be scheduled (hereinafter also called “indicative data”). Arrow 1 in FIG. 2 illustrates that indicative data is received from input device 220, which may be a keyboard configured to input electronic data to a desktop or laptop computer. When scheduling meetings on a mobile computer system, input device 220 may instead be an input user interface similar to input user interface 103 or may be an input user interface of a PDA, pager, or other mobile computer system. Input device 220 may also be a pointing device such as a mouse. It may also be that input device 220 is an audio input device such as a microphone associated with a desktop or laptop computer system or a microphone similar to microphone 106.

In some embodiments, scheduling computer system 200 may receive indicative data from a remote computer system, where the indicative data is transferred to scheduling computer system 200 over a logical communication link. For example, a remote computer system may access scheduling computer system 200 over a network connection and cause indicative data to be received at meeting scheduler 201. Such remote computer systems may be computer systems that contain the information logically represented by relevant information 210.

In other embodiments, scheduling computer system 200 may include decision logic that causes indicative data to be received at meeting scheduler 201. Such decision logic may be included in meeting scheduler 201 or may be in a module external to meeting scheduler 201. In these embodiments, indicative data may be transferred between the internal modules of scheduling computer system 200 over a logical communication path or over a system bus similar to bus 110.

Meeting scheduler 201 may process indicative data to determine that a meeting is to be scheduled among a plurality of meeting attendants.

Step 404 may include accessing information relevant to the availability of at least some of the plurality of meeting attendants (act 402). Arrow 2 in FIG. 2 illustrates meeting scheduler 201 may access data from relevant information 210. Accessed data may include, for example, data indicating when an meeting attendant is free and when they are busy (“free/busy time”), the location of an meeting attendant, a priority level for an meeting attendant, and whether or not a meeting attendant is a required or optional attendant.

Based on relevant information, at least one potential meeting is automatically determined (act 403). Relevant information may be analyzed to determine a meeting that appropriately satisfies predetermined criteria. This may include meeting scheduler 201 utilizing decision logic to determine, based on the relevant information, a meeting that appropriately satisfies predetermined criteria 202. Predetermined criteria may include, for example, that a specified percentage of the plurality of meeting attendants be available at a specified time, that all required attendants be available at a specified time, that meeting attendants be available to attend in a specified location, etc. A potential meeting that satisfies predetermined criteria, for example, may be any meeting where at least 90 percent of the meeting attendants are free during the time period over which the potential meeting would be scheduled. It should be understood that these are merely examples of predetermined criteria. It would be apparent to one skilled in the art, after having reviewed this description, that the type and number of predetermined criteria are virtually limitless.

Decision logic in meeting scheduler 201 may also analyze relevant information to determine a potential meeting that satisfies a plurality of different predetermined criteria. For example, a potential meeting that satisfies predetermined criteria may be a meeting where 100 percent of the required meeting attendants are available to meet in a specific location at a specific time. If 100 percent of the meeting attendants are available at the specific time but not the specific location, or vice versa, the predetermined criteria will not be satisfied. Decision logic in meeting scheduler 201 may combine or aggregate different portions or relevant information to generate a value representative of the appropriateness of a potential meeting. Such representative values may be analyzed to determine potential meetings.

If not all predetermined criteria can be satisfied, an appropriate meeting may be a meeting that satisfies an increased number of predetermined criteria. It may be that predetermined criteria designate that 90 percent of meeting attendants be available to attend a meeting at a specific time and in a specific location. A potential meeting where 85 percent are available may be preferred over a potential meeting where 75 percent are available. Additionally, different predefined criteria may be assigned different levels of importance. For example, the percentage of attendants may be important in some situations, while meeting location is important in other situations. The levels of importance for predefined criteria may be configured by setting other predetermined criteria.

It may also be that if not all predetermined criteria can be satisfied, an appropriate meeting may be a meeting that more closely satisfies particular predetermined criteria. When scheduling a two-hour meeting, predetermined criteria may indicate that all potential meeting attendants must attend. An appropriate meeting may result where some meeting attendants are only available for a portion of the two-hour meeting. A level of strictness with which relevant information must satisfy certain predetermined criteria may be configured by setting other predetermined criteria.

In one example embodiment, a plurality of potential meetings may be automatically determined. The meetings may be ranked in a recommended order based on the strictness with which the meetings satisfy predetermined criteria and/or the levels of importance for specific predetermined criteria. Meetings that satisfy predetermined criteria more strictly or that satisfy predetermined criteria with higher levels of importance may be ranked higher. Likewise, meetings that satisfy predetermined criteria less strictly or that satisfy predetermined criteria with lower levels of importance may be ranked lower.

Predetermined criteria may be user-configurable through a user interface or may be automatically configured by scheduling computer system 200.

After determining at least one potential meeting time, the scheduling computer system may present a list of meetings to an output device. Arrow 3 in FIG. 2 illustrates that a list of meetings is transferred to output device 230, which may be a computer monitor or laptop display device. A list of meetings may be output in a recommended order where higher ranked meetings are output before lower ranked meetings or where higher ranked meetings are included before lower ranked meetings in the list. When scheduling meetings on a mobile computer system, output device 230 may instead be a display similar to display 105 or may be the display of a PDA, pager, or other mobile computer system. Output device 230 may also be an audio output device such as a speaker associated with a desktop or laptop computer system or a speaker similar to speaker 104.

In some embodiments, a meeting organizer may select a meeting from the list of at least one meeting. Relevant information associated with the selected meeting, such as date, time, and location may be sent to meeting attendants. In other embodiments, the list of at least one meeting is sent to meeting attendants. From the list, each meeting attendant may vote for the most desirable meeting. The selected meeting may be the meeting that receives the most votes. Additional meeting attendants may be invited to currently-scheduled meetings. When this occurs, an additional meeting attendant may be sent relevant information associated with the currently-scheduled meeting.

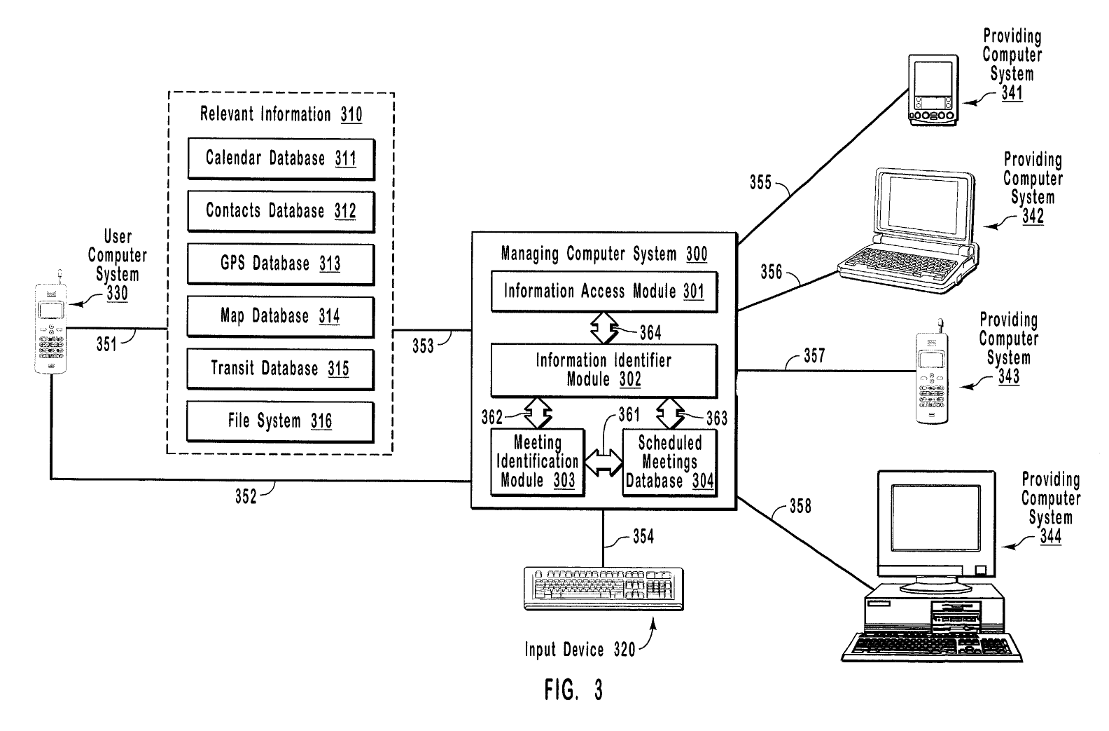

FIG. 3 illustrates an example of some of the functional components that may facilitate managing a meeting. Shown in FIG. 3 is managing computer system 300, which may be a general-purpose computer system that includes components similar to those previously discussed herein. Managing computer system 300 may provide complex and flexible general-purpose processing capabilities. Managing computer system 300 includes meeting identification module 303, which may identify information as being associated with a currently-scheduled meeting. Meeting identification module 303 may refer to scheduled meetings database 304, which includes at least a list of currently scheduled-meetings, when making such an identification. Managing computer system 300 also includes information identifier module 302, which may identify information that is relevant to a currently-scheduled meeting, and information access module 301, which may access information that is relevant to a currently-scheduled meeting. The modules and databases included in managing computer system 300 may communicate via logical communication paths 361-364.

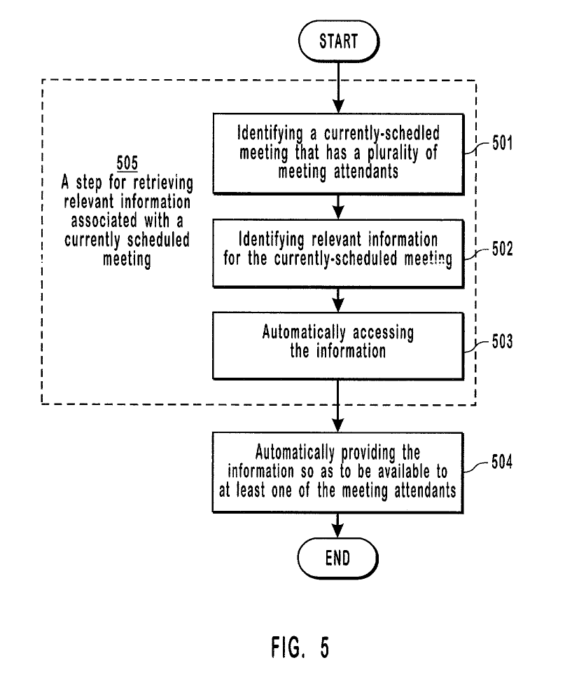

FIG. 5 is a flow diagram illustrating an example of a method for increasing the level of automation when managing scheduled meetings. The method in FIG. 5 will be discussed with reference to the functional components included in FIG. 3.

The method in FIG. 5 may begin with a step for retrieving relevant information associated with a currently-scheduled meeting (step 505). This may include managing computer system 300 retrieving relevant information from relevant information 310. Relevant information 310 logically represents a store of information that may reside in disparate physical locations and that may be relevant to the management of scheduled meetings. The databases included in relevant information 310 contain information that may be relevant to managing a currently-scheduled meeting. Relevant information 310 may include information similar to that included in relevant information 210. Relevant information 310 may also include other information related to the management of currently-scheduled meetings, such as transit data contained in transit database 315 and data files contained in file system 316. Transit database 315 may include data on traffic congestion, road construction, or other data related to traveling in an area under the jurisdiction of a transit authority. File system 316 may include data files that are associated with a currently-scheduled meeting, such as word processing documents or graphical presentations. Managing computer system 300 may retrieve data from relevant information 310 via logical communication path 353.

Managing computer system 300 may also retrieve relevant information from user computer system 330. This may occur if a user associated with user computer system 300 changes information that is relevant to a currently-scheduled meeting. For example, if a user of user computer system 300 changes his or her availability for a currently-scheduled meeting or modifies a file associated with a currently-scheduled meeting, this may be retrieved by managing computer system 300. Managing computer system 300 may retrieve data from user computer system 330 via logical communication path 352.

Step 505 may include identifying a currently-scheduled meeting that has a plurality of meeting attendants (act 501). When managing computer system 300 receives data, meeting identification module 303 may determine that the data is meeting management data. Meeting identification module 303 may refer to scheduled meeting database 304 to further determine if the meeting management data is associated with a currently-scheduled meeting.

Meeting management data may be received from relevant information 310, user computer system 352, or managing computer system 300. Meeting management data may include data associated with a meeting attendant, meeting location, or subject matter of a meeting. In some embodiments, meeting management data may be updated at a remote computer system. For example, an individual may update their time availability on user computer system 330. Meeting management data representative of the updated time availability may be received at meeting identification module 303. Meeting identification module 303 may refer to scheduled meetings database 304 to determine if the meeting management data is associated with a meeting attendant and if the change in time availability affects any currently-scheduled meetings. A currently-scheduled meeting may be affected, for example, if a required meeting attendant is no longer available to attend. If a currently-scheduled meeting is affected, meeting identification module 303 may determine that meeting management data is associated with a currently-scheduled meeting and thus identify the currently-scheduled meeting.

In some embodiments, relevant information 310 may be updated and the update, in the form of meeting management data, is received at meeting identification module 303. For example, a document included in file system 316 may be edited and saved. Meeting management data associated with the document being edited may be received at meeting identification module 303. Meeting identification module 303 may refer to scheduled meetings database 304 to determine if document is associated with any currently-scheduled meetings. If the document is associated with a currently-scheduled meeting, meeting identification module 303 may identify the currently-scheduled meeting. Relevant information 310 may be updated in response to events associated with user computer system 330. For example, if user computer system 330 contains a GPS transmitter, GPS database 213 may be updated as user computer system 330 moves between physical locations.

When determining if meeting management data is associated with a currently-scheduled meeting, identification module 303 may refer to databases included in relevant information 310. It may be that meeting management data associated with a change in the location of an individual is received at meeting identification module 303. Meeting identification module 303 may refer to scheduled meetings database 304, as well as map database 314 and transit database 315, to determine if the meeting management data affects any currently-scheduled meetings. A meeting may be affected, for example, if an individual is a meeting attendant and severe traffic congestion is being experienced at the individual's current location.

In some embodiments, meeting identification module 303 may receive meeting management data from input device 320.

Step 505 may include identifying relevant information for the currently-scheduled meeting (act 502). Identifying relevant information may include identifying data included in user computer system 330, relevant information 310, or managing computer system 300. After a currently-scheduled meeting is identified, meeting identification module 303 may transfer the identification to information identifier module 302. Information identifier module 302 may identify the information that is relevant to the identified currently-scheduled meeting. This may include identifying addresses and/or pointers to relevant information. A pointer may designate a location in the system memory of a computer system or a location on a mass storage device associated with a computer system. An address may be an electronic messaging addresses associated with meeting attendants that desire to receive the relevant information.

Information identifier module 302 may identify relevant information that is associated with the meeting management data that caused a currently-scheduled meeting to be identified. It may be that a currently-scheduled meeting was identified due to receiving meeting management data associated with edits being performed in a relevant document. As a result, information identifier module 302 may identify other documents that link to the relevant document or that include embedded data from the relevant document. Information identifier module 302 may refer to scheduled meetings database to determine the relationships between meeting management data and other relevant information. Likewise, reference may be made to the databases included in relevant information 310 and/or modules included in user computer system 330 to determine relationships between meeting management data and other relevant information. For example, when a GPS transmitter included in user computer system 330 is detected in a specified location it may be desirable to also identify an associated map.

Step 505 may include automatically accessing the information (act 503). Information access module 301 may automatically access relevant information by utilizing addresses and/or pointers that were identified by information identifier module 302. This may include accessing information from user computer system 330, relevant information 310, and/or scheduled meetings database 304.

The information may be automatically provided so as to be available to at least one of the meeting attendants (act 504). Relevant information may be transferred in the form of electronic messages to computer systems that are associated with meeting attendants. For example, providing computer systems 341-344 may each be associated with meeting attendants of a currently scheduled meeting. Relevant information may be provided over logical communication paths 355-358 to one or more of the providing computer systems 341-344. When providing relevant information, previously identified electronic messaging addresses may be utilized.

In some cases, different providing computer systems are provided with different relevant information. Managing computer system 300 may determine which providing computer systems are to receive which relevant information. Managing computer system 300 and/or a providing computer system may be configured to filter out specified relevant information so the specified relevant information is not provided to the providing computer system. For example, a meeting attendant associated with providing computer system 341 may desire to receive availability information for required meeting attendants but not for optional meeting attendants. When the availability of an optional meeting attendant is updated, managing computer system 300 will not provide relevant information about the optional meeting attendant to providing computer system 341.

An administrative entity may control specified relevant information that is filtered out for a meeting attendant. An administrative entity may filter specified relevant information when it is not desirable for a meeting attendant to be provided with the specified relevant information. For example, a sales agent meeting with a client may be provided with updated information about the client from the sales agent's corporate database, however the updated information is not provided to the client.

After identifying a currently-scheduled meeting that has a plurality of meeting attendants (act 601), managing computer system 300 may perform a step for rescheduling a currently-scheduled meeting (step 604). Managing computer system 300 may monitor relevant information, such as, for example, meeting management data, associated with a currently-scheduled meeting. Step 604 may include an act of managing computer system 300 detecting a change in relevant information associated with the currently-scheduled meeting (act 602). Managing computer system 300 may detect that a portion of meeting management data, such as, for example, the availability of a meeting participant or of the location where the currently-schedule meeting is to occur, has been updated.

Step 604 may include an act of managing computer system 300 automatically providing at least an option to reschedule the currently-scheduled meeting so as to be available to at least one of the meeting attendants (act 603). Managing computer system 300 may be configured to suggest one or more possible options for rescheduling the currently-scheduling meeting, such as, for example, scheduling the currently-scheduled meeting at a different time and/or in a different location. Managing computer system 300 may transfer the possible options to computer systems that are associated with the meeting attendants. A meeting attendant may select one of the possible options to attempt to reschedule the currently-scheduled meeting. In some cases, meeting attendants with higher priority or that are required attendants may receive possible options, while attendants with lower priority or that are optional do not receive possible options. Managing computer 300 may be configured to automatically reschedule the currently-scheduled meeting without input from any meeting attendants. Managing computer 300 may follow the method of FIG. 4 when automatically rescheduling a meeting or rescheduling a meeting after receiving meeting attendant input.

Increasing the level of automation when scheduling managing meetings reduces the amount of data that is interpreted by individual meeting organizers and meeting attendants. This promotes efficient scheduling of meetings and reduces the chance of human error in the scheduling process. Automatically accessing and providing relevant information to meeting attendants centralizes the distribution of such information. This promotes time efficiency by relieving individual meeting attendants from having to actively seek out the information. In a mobile environment, increased automation may provide certain safety benefits as well. For example, automatically updating the status of a meeting attendant who is late due to traffic congestion may free the meeting attendant from having to manually manipulate a mobile computer system. Thus, the meeting attendant may devote more attention to safe operation of their vehicle.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes, which come within the meaning and range of equivalency of the claims, are to be embraced within their scope.

What is claimed and desired secured by United States Letters Patent is:

1. In a network environment that includes at least a scheduling computer system, a method for scheduling meetings for a user so as to relieve an individual meeting organizer from having to manually record and interpret availability data for meeting attendants, the method comprising the following:
an act of determining that a meeting is to be scheduled among a plurality of meeting attendants;
an act of accessing supplemental information relevant to at least some of the plurality of meeting attendants; and
an act of automatically determining at least one potential meeting based on the supplemental information.

2. The method as recited in claim 1, wherein the act of determining that a meeting is to be scheduled among a plurality of meeting attendants comprises the following:
an act of receiving data indicating that a meeting is to be scheduled.

3. The method as recited in claim 23 wherein the act of receiving data indicating that a meeting is to scheduled comprises the following:
act of receiving data from a computer system that is network connectable to the scheduling computer system.

4. The method as recited in claim 2, wherein the act of receiving data indicating that a meeting is to scheduled comprises the following:
an act of receiving data from an input device associated with the scheduling computer system.

5. The method as recited in claim 2, wherein the act of receiving data indicating that a meeting is to scheduled comprises the following:
an act of receiving data from the scheduling computer system.

6. The method as recited in claim 1, wherein the act of determining that a meeting is to be scheduled among a plurality of meeting attendants comprises the following:
an act of processing data indicating that a meeting is to be scheduled.

7. The method as recited in claim 1, wherein the act of accessing supplemental information relevant to at least some of the plurality of meeting attendants comprises the following:
an act of accessing primary information for at least some of the plurality of meeting attendants along with supplemental information for at least some of the plurality of meeting attendants.

8. The method as recited in claim 1, wherein the act of accessing supplemental information relevant to least some of the plurality of meeting attendants comprises the following:
an act of accessing priority levels for at least some of the plurality of meeting attendants.

9. The method as recited in claim 1, wherein the act of accessing supplemental information relevant to at least some of the some of the plurality of meeting attendants comprises the following:
an act of accessing data files that are relevant to at least some of the meeting attendants.

10. The method as recited in claim 1, wherein the act of automatically determining at least one potential meeting based on the supplemental information comprises the following:
an act of a meeting scheduler automatically determining at least one potential meeting.

11. The method as recited in claim 1, wherein the act of automatically determining at least one potential meeting based on the supplemental information comprises the following:
an act of automatically determining that at least one potential meeting satisfies predetermined criteria.

12. The method as recited in claim 1, wherein the act of automatically determining at least one potential meeting based on the supplemental information comprises the following:
an act of automatically determining rankings for a plurality of potential meetings.

13. The method as recited in claim 12, wherein the act of automatically determining rankings for a plurality of potential meetings comprises the following:
an act of automatically determining rankings for a plurality of potential meetings based on the strictness with which the meetings satisfy predetermined criteria.

14. The method as recited in claim 12, wherein the act of automatically determining rankings for a plurality of potential meetings comprises the following:
an act of automatically determining rankings for a plurality of potential meetings based on the of the level of the predetermined criteria that are satisfied.

15. The method as recited in claim 1, further comprising:
an act of presenting the at least one potential meeting at an output device.

16. In a network environment that includes at least a scheduling computer system, a method for scheduling meetings for a user so as to relieve an individual meeting organizer from having to manually record and interpret availability data for meeting attendants, the method comprising the following:
a step for receiving availability information for one or more meeting attendants; and
an act of automatically determining at least one potential meeting time based on the information.

17. In a network environment that includes at least a managing computer system, a method for managing currently-scheduled meetings for a user so as to notify meeting attendants of relevant information associated with a currently-scheduled meeting, the method comprising the following:
an act of identifying a currently-scheduled meeting that has a plurality of meeting attendants;
an act of identifying relevant information for the currently-scheduled meeting;
an act of automatically accessing the information; and
an act of automatically providing the information so as to be available to at least one of the meeting attendants.

18. The method as recited in claim 17, wherein the act of identifying a currently-scheduled meeting that has a plurality of meeting attendants comprises the following:
an act of a meeting identification module receiving meeting management data associated with a currently-scheduled meeting.

19. The method as recited in claim 17, wherein the act of a meeting identification module receiving meeting management data associated with a currently-scheduled meeting comprises the following:
an act of receiving meeting management data associated with change in the availability of a meeting attendant.

20. The method as recited in claim 17, wherein the act of a meeting identification module receiving meeting management data associated with a currently-scheduled meeting comprises the following:
an act of receiving meeting management data associated with a change in the availability of a location.

21. The method as recited in claim 17, wherein the act of a meeting identification module receiving meeting management data associated with a currently-scheduled meeting comprises the following:
an act of receiving meeting management data associated with a change in a document.

22. The method as recited in claim 17, wherein the act of identifying a currently-scheduled meeting that has a plurality of meeting attendants comprises the following:
an act of referring to a scheduled meetings database.

23. The method as recited in claim 17, wherein the act of identifying relevant information for the currently-scheduled meeting comprises the following:
an act of identifying addresses associated with the relevant information.

24. The method as recited in claim 17, wherein the act of identifying addresses associated with the relevant information comprises the following:
an act of identifying electronic messaging addresses associated with meeting attendants that are to attend the currently-scheduled meeting.

25. The method as recited in claim 17, wherein the act of identifying relevant information for the currently-scheduled meeting comprises the following:
an act of identifying relevant information contained in at least one remote computer system that is network connectable to the managing computer system.

26. The method as recited in claim 17, wherein the act of automatically accessing the information comprises the following:
an act of automatically accessing information contained in at least one remote computer system that is network connectable to the managing computer system.

27. The method as recited in claim 17, wherein the act of automatically providing the information so as to be available to at least one of the meeting attendants comprises the following:
an act of automatically providing an electronic message that includes at least a portion of the information.

28. The method as recited in claim 17, wherein the act of automatically providing the information so as to be available to at least one of the meeting attendants comprises the following:
an act of automatically providing an electronic message to an electronic message address associated with at least one of the meeting attendants.

29. In a network environment that includes at least a managing computer system, a method for managing currently-scheduled meetings for a user so as to notify meeting attendants of relevant information associated with a currently-scheduled meeting, the method comprising the following:
a step for retrieving relevant information associated with a currently-scheduled meeting so as to relieve the user from having to manually interact with the information; and
an act of automatically providing the relevant information to at least one of the meeting attendants.

30. A computer program product for use in a network environment that includes at least a scheduling computer system, the computer program product for implementing a method for scheduling meetings for a user so as to relive an individual meeting organizer from having to manually record and interpret free/busy times for meeting attendants, the computer program product comprising the following:
one or more computer-readable media carrying computer-executable instructions, that when executed at the scheduling computer system, cause the scheduling computer system to perform the method, including:
determining that a meeting is to be scheduled among a plurality of meeting attendants;
accessing information relevant to the availability of at least some of the plurality of meeting attendants; and
determining at least one potential meeting time based on the information.

31. The computer program product as recited claim 30, wherein the one or more computer-readable media include physical storage media.

32. The computer program product as recited claim 30, wherein the one or more computer-readable media include system memory.

33. A computer program product for use in a network environment that includes at least a managing computer system, the computer program product for implementing a method for managing currently-scheduled meetings for a user so as to notify meeting attendants of relevant information associated with a currently-scheduled meeting, the computer program product comprising the following:
one or more computer-readable media carrying computer-executable instructions, that when executed at the managing computer system, cause the managing computer system to perform the method, including:
identifying a currently-scheduled meeting that has a plurality of meeting attendants;
identifying relevant information for the currently-scheduled meeting;
accessing the relevant information for the currently-scheduled meeting; and
providing the relevant information so as to be available to at least one of the meeting attendants.

34. The computer program product as recited claim 33, wherein the one or more computer-readable media include physical storage media.

35. The computer program product as recited claim 33, wherein the one or more computer-readable media include system memory.

36. A network system for managing relevant information associated with a meeting, comprising:
a managing computer system that is configured to identify a currently-scheduled meeting and relevant information associated with the currently-scheduled meeting and automatically provide the relevant information to at least one providing computer system; and
a providing computer system that is network connectable to the managing computer system, that includes an output device, and is configured to receive relevant information for the currently-scheduled meeting from the managing computer system and output the relevant information at the output device.

37. In a network environment that includes at least a managing computer system, a method for managing currently-scheduled meetings for meeting attendants so as to notify the meeting attendants of a change in a currently-scheduled meeting, the method comprising the following:
an act of identifying a currently-scheduled meeting that has a plurality of meeting attendants;
an act of detecting a change in relevant information associated with the currently-scheduled meeting; and
an act of automatically providing at least an option to reschedule the currently-scheduled meeting so as to be available to at least one of the meeting attendants.

38. The method as recited in claim 37, wherein the act of detecting a change in relevant information associated with the currently-scheduled meeting comprises the following:
an act of detecting a change in the availability of one of the plurality of meeting participants.

39. The method as recited in claim 37, wherein the act of detecting a change in relevant information associated with the currently-scheduled meeting comprises the following:
an act of detecting a change in the availability of the location where the currently-scheduled meeting is to occur.

40. The method as recited in claim 37, wherein the act of automatically providing at least an option to reschedule the currently-scheduled meeting so as to be available to at least one of the meeting attendants comprises the following:
an act of automatically providing suggested changes to the currently-scheduled meeting.

41. The method as recited in claim 37, wherein the act of automatically providing at least an option to reschedule the currently-scheduled meeting so as to be available to at least one of the meeting attendants comprises the following:
an act of automatically rescheduling the currently-scheduled meeting.

42. In a network environment that includes at least a managing computer system, a method for managing currently-scheduled meetings for meeting attendants so as to notify the meeting attendants of a change in a currently-scheduled meeting, the method comprising the following:
an act of identifying a currently-scheduled meeting that has a plurality of meeting attendants; and
a step for rescheduling the currently-scheduled meeting.

43. A computer program product for use in a network environment that includes at least a managing computer system, the computer program product for implementing a method for managing currently-scheduled meetings for meeting attendants so as to notify the meeting attendants of a change in a currently-scheduled meeting, the computer program product comprising the following:
one or more computer-readable media carrying computer-executable instructions, that when executed at the managing computer system, cause the managing computer system to perform the method, including:
identifying a currently-scheduled meeting that has a plurality of meeting attendants;
detecting a change in relevant information associated with the currently-scheduled meeting; and
providing at least an option to reschedule the currently-scheduled meeting so as to be available to at least one of the meeting attendants.

44. The computer program product as recited claim 43, wherein the one or more computer-readable media include physical storage media.

45. The computer program product as recited claim 43, wherein the one or more computer-readable media include system memory.
